(19) United States
(12) Patent Application Publication
(10) Pub. No.: US 2026/0048518 A1
(43) Pub. Date: Feb. 19, 2026

(54) ELECTRIC HAIR CUTTING DEVICE WITH BLADESET LOCKING MECHANISM

(71) Applicant: WAHL CLIPPER CORPORATION, Sterling, IL (US)

(72) Inventor: Gary Lee SNOW, Rock Falls, IL (US)

(21) Appl. No.: 18/874,270

(22) PCT Filed: May 22, 2023
(86) PCT No.: PCT/US2023/023105

§ 371 Date: Dec. 12, 2024

Related U.S. Application Data
(60) Provisional application No. 63/367,091, filed on Jun. 27, 2022.

(51) Int. Cl. B26B 19/06; B26B 19/38

(52) U.S. Cl. CPC B26B 19/06; B26B 19/3846

(57) ABSTRACT

An electric hair cutting device with a bladeset assembly locking mechanism includes a housing and a bladeset assembly attached to the housing. The bladeset assembly includes a stationary blade, a movable blade that is movable relative to the stationary blade, and at least one pin extending from the stationary blade. A locking mechanism is also provided. The locking mechanism includes a bracket and a biasing element. The biasing element acts upon the bracket to bias the bracket into engagement with the at least one pin. The at least one pin includes a recess. The bracket seats in the recess in a locked position of the locking mechanism such that movement of the blade assembly in an unlocking direction parallel to a longitudinal axis of the at least one pin is prevented.

### FIELD OF THE INVENTION

The present invention relates generally to hair clippers and hair trimmers, and more specifically to devices designed for enhancing the maintenance, cleaning and/or adjustment of clipper and trimmer bladesets.

### BACKGROUND

The present invention relates generally to hair clippers and hair trimmers, and more specifically to devices designed for enhancing the maintenance, cleaning and/or adjustment of clipper and trimmer bladesets.

Electric hair clippers and trimmers, collectively referred to here as hair clippers, conventionally use a removable bladeset including a stationary blade and a moving blade, which reciprocates laterally relative to the stationary blade. Hair which is caught between respective teeth of the moving and stationary blades is clipped as the moving blade teeth move past the stationary blade teeth under the power of an internal electric motor. For barbers and other professional hair stylists, collectively referred to as hair stylists, who use electric hair clippers, changes in the orientation of the tips of the moving blade relative to the fixed blade are known to provide different hair styling effects. Typically, the main effect of the blade position is to alter the cut length of the subject's hair. Another such effect is providing a sharp outline of the subject's hair relative to their neck, and also to provide geometric designs cut into the subject's hair. As such, hair stylists often have designated hair clippers which are intended to provide specific styling effects and have bladesets that are pre-adjusted.

Many types of conventional hair clippers are provided with blade mounting brackets having locating bushings which are adjustable by the hair stylist to achieve the desired stationary/moving blade tip spacing. Such locating bushings are conventionally held in place by threaded fasteners.

Other types of hair clippers are provided with an adjustment lever used to move the stationary blade relative to the moving blade as an alternate mechanism for providing the above-listed styling effects. Such adjustment levers allow the stylist to adjust the clipper as needed to achieve desired effects at the time of the styling operation. More specifically, one desired styling effect is to “taper” or “blend” the length of hair to affect the quality of the resulting hair style.

Another design criterion of hair clippers is that the bladesets need to be periodically removed from the hair clipper body for cleaning and/or maintenance. In most conventional hair clipper bladesets, this operation is accomplished by loosening and removing at least one threaded fastener that secures the bladeset to a bracket on the hair clipper. Depending on the hair clipper design, this removal of the bladeset may or may not require readjustment of the relative spacing of the blades during operation. Regardless, the bladeset removal operation is considered laborious by many hair stylists.

Thus, there is a need for an improved mechanism for removing hair clipper bladesets for cleaning and/or maintenance. There is also a need for an improved mechanism for removing hair clipper bladesets that preserves the pre-adjusted relationship of the moving blade to the stationary blade.

### SUMMARY

In one aspect, a hair cutting device is provided with a removable bladeset assembly. An embodiment according to this aspect includes a housing and a bladeset assembly attached to the housing. The bladeset assembly includes a stationary blade, a movable blade that is movable relative to the stationary blade, and at least one pin extending from the stationary blade. A locking mechanism is also provided. The locking mechanism includes a bracket and a biasing element. The biasing element acts upon the bracket to bias the bracket into engagement with the at least one pin. A feature of the at least one pin is that it includes a recess. The bracket seats in the recess in a locked position of the locking mechanism such that movement of the blade assembly in an unlocking direction parallel to a longitudinal axis of the at least one pin is prevented.

In an embodiment according to this aspect, the at least one pin includes a pair of pins, which each one of the pair of pins including the recess.

In an embodiment according to this aspect, the biasing element is a spring, and wherein the spring is interposed between a base portion of the bracket and a retaining tab of the housing.

In an embodiment according to this aspect, the bracket includes a pair of pin receiving portions. Each one of the pair of pin receiving portions defines a slot. The slots are arranged for receiving the pair of pins, respectively. Each pin receiving portion includes an arcuate surface facing an interior region of the slot. Each arcuate surface of each pin receiving portion is arranged for sliding engagement with a head portion of the pin received in the slot.

In another aspect, a hair cutting device is provided that does not require the use of hand tools for removing a bladeset assembly. An embodiment according to this aspect includes a housing and a bladeset assembly attached to the housing. The bladeset assembly includes a stationary blade, a movable blade that is movable relative to the stationary blade, and a pair of pins extending from the stationary blade. A locking mechanism is also provided. The locking mechanism includes a bracket and a biasing element.

Preferably, the biasing element acts upon the bracket to bias the bracket into engagement with pair of pins. A pair of pin receiving portions are included on the bracket. The pin receiving portions are arranged to receive the pair of pins such that each one of the pair of pins extends through the pin receiving portion of the bracket, respectively.

In an embodiment according to this aspect, each one of the pair of pins includes a recess. Each recess is arranged such that each pin receiving portion of the pair of receiving portions seats within each recess, respectively.

In an embodiment according to this aspect, the biasing element is interposed between a base portion of the bracket and a retaining tab of the housing. A cutting line is defined by the movable blade and stationary blade. The biasing element biases the bracket away from the cutting line.

In an embodiment according to this aspect, the pair of pins are fixedly attached to the stationary blade. Each one of the pair of pin receiving portions defines a slot. The slots are arranged for receiving the pair of pins, respectively. Each pin receiving portion includes an arcuate surface facing an interior region of the slot. Each arcuate surface of each pin receiving portion is arranged for sliding engagement with a head portion of the pin received in the slot.

In another aspect, a hair cutting device is provided having a push button bladeset assembly release configuration. An embodiment according to this aspect includes a housing and a bladeset assembly attached to the housing. The bladeset assembly includes a stationary blade, and a movable blade that is movable relative to the stationary blade. A cutting line is defined by the movable blade and stationary blade. A pair of pins extend from the stationary blade. A locking mechanism is also provided. A bracket and a biasing element are included in the locking mechanism. The bracket includes a pair of pin receiving portions. In a preferred embodiment, the biasing element acts upon the bracket to bias the bracket into engagement with the pair of pins. The biasing element is interposed between a base portion of the bracket and a retaining tab of the housing such that the bracket is biased away from the cutting line.

In an embodiment according to this aspect, each one of the pair of pins includes a recess, with each recess arranged such that each pin receiving portion of the pair of pin receiving portions seats within each recess, respectively. Each one of the pair of pin receiving portions defines a slot, the slots arranged for receiving the pair of pins, respectively. Each pin receiving portion includes an arcuate surface facing an interior region of the slot. Each arcuate surface of each pin receiving portion is arranged for sliding engagement with a head portion of the pin received in the slot. The pair of pins are fixedly attached to the stationary blade.

### BRIEF DESCRIPTION OF THE DRAWINGS

FIG. 1 is a perspective view of an exemplary embodiment of an electric hair cutting device incorporating a bladeset locking mechanism according to the teachings herein;

FIG. 2 is a perspective assembly view of the embodiment of FIG. 1, illustrating a bladeset assembly of the device in spatial relation to a remainder of the device;

FIG. 3 is a partial perspective view of the device of FIG. 1, with the bladeset assembly of FIG. 2 removed to expose a bladeset receiving region of the device;

FIG. 4 is a partial perspective view of the device of FIG. 1, with an upper housing portion removed to expose a bladeset locking mechanism of the device, with the bladeset locking mechanism shown in a locked position;

FIG. 5 is a partial perspective view of the device of FIG. 1, with the upper housing portion removed to expose the bladeset locking mechanism of the device, with the bladeset locking mechanism shown in an unlocked position;

FIG. 6 is a perspective view of a locking bracket of the bladeset locking mechanism; and

FIG. 7 is a partial perspective vertical cross-section taken through a locking pin of the bladeset assembly of FIG. 2.

### DETAILED DESCRIPTION

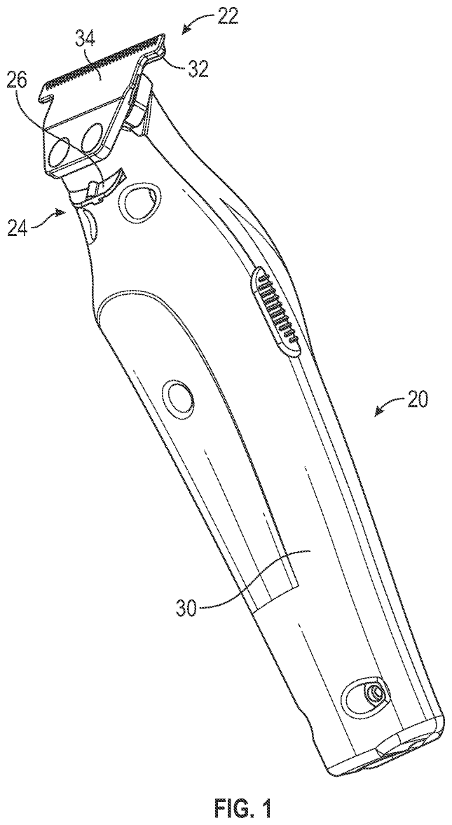

Turning now to the drawings, FIG. 1 illustrates an embodiment of an electric hair cutting device 20 including a bladeset assembly 22 and bladeset locking mechanism 24 according to the teachings herein. As will be described in greater detail below, locking mechanism 24 advantageously allows a user to easily remove bladeset assembly 22 from a remainder of device 20. Locking mechanism 24 is configured such that bladeset assembly 22 can be removed entirely by hand, without the use of any tools. Such removal may be useful for periodic maintenance, cleaning, and lubrication of the constituent componentry of bladeset assembly 22.

Device 20 is illustrated as a hair trimmer. However, it will be readily recognized from the teachings herein that hair cutting device may be any contemporary electric hair cutting device, e.g. a hair clipper, a hair trimmer, which in either case may be corded or cordless. Device 20 includes an outer housing 30. Housing 30 encloses in an interior thereof a rotary motor and associated eccentric cam for driving a movable blade 32 relative to a stationary blade 34 of bladeset assembly 22 to cut hair fed into blade assembly 22. The basic operation of the rotary motor and eccentric cam are the same as the basic operation of that described in U.S. Pat. No. 9,545,729 to Buck et al., the teachings and disclosures of which are incorporated by reference herein in their entirety.

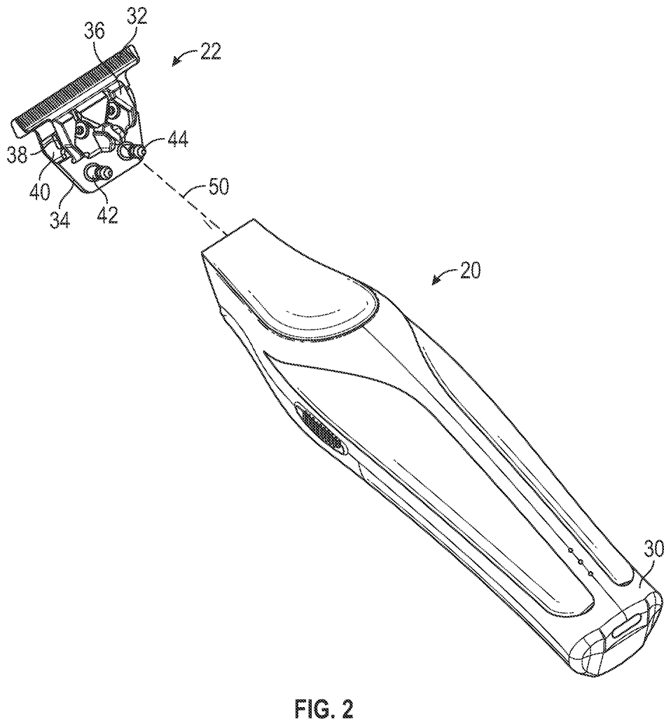

Turning now to FIG. 2, bladeset assembly 22 is illustrated removed from the remainder of device 20. Such removal is made possible by depression of a bracket 26 (see FIG. 1) of locking mechanism 24. Bladeset assembly 22 also includes a cam follower 36 attached to movable blade 32 and to a blade guide 38. Blade guide 38 seats within a lateral channel 40, thereby constraining the movement of both movable blade 32 and cam follower 36 to a lateral reciprocating motion as the aforementioned eccentric cam engages cam follower 36.

As least one pin, and in the illustrated embodiment, a pair of pins 42, 44 extend away from stationary blade 34. Pins 42, 44 may be integrally formed with stationary blade 34, or may be attached thereto. For example, pins 42, 44 may be fastened, welded, press fit, adhered, or otherwise fixedly attached to stationary blade 34. As explained in greater detail below, pins 42, 44 are acted upon by locking mechanism 24 to retain bladeset assembly 22 to housing 30 and the remainder of device 20.

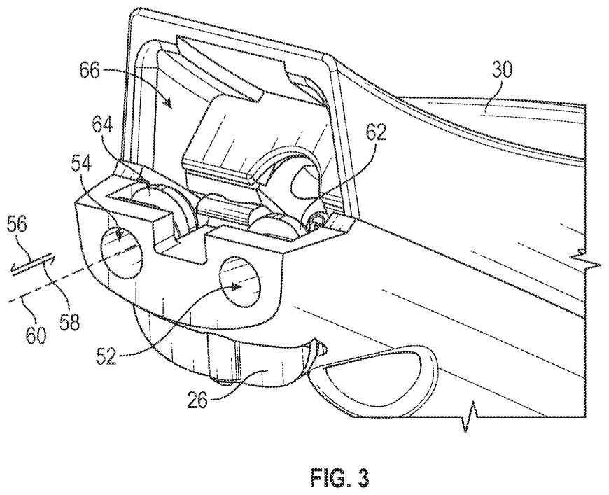

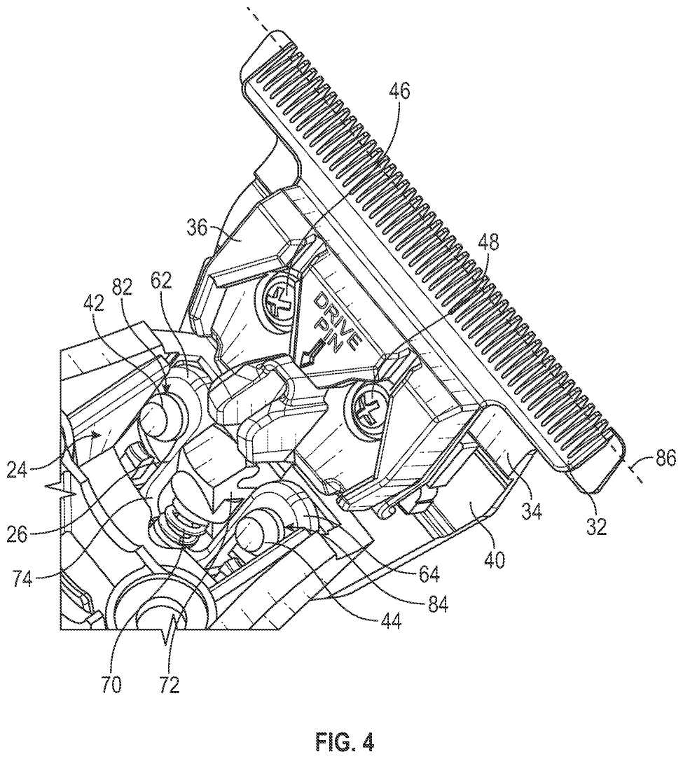

With reference now to FIG. 3, a pair of bores 52, 54 are arranged on housing 30 and configured to receive pins 42, 44 (see FIG. 2), respectively. Pins 42, 44 are slidable within bores 52, 54 in directions 58, 56 parallel to a longitudinal axis 60 defined by either or both bores 52, 54 as shown. Bores 52, 54 terminate in proximity to bracket 26 of locking mechanism 24. When bladeset assembly 22 (see FIG. 1) is fully installed, pins 42, 44 extend entirely through bores 52, 54 and are in contact with bracket 26 as shown in FIG. 4.

As explained below, bracket 26 is biased into engagement with pins 42, 44 to thereby prevent removal of bladeset assembly 22 absent depression of bracket 26. In such a position, bladeset assembly 22 is in a locked position. When a user desires to remove bladeset assembly 22 (i.e. to place bladeset assembly 22 in an unlocked position), the user may depress an exposed portion of bracket 26 as shown in FIG. 3, which in turn disengages bracket 26 from pins 42, 44. When bracket 26 is disengaged from pins 42, 44, bladeset assembly 22 may be removed along direction 56 as shown. More particularly, bracket 26 includes pin engagement portions 62, 64 which engage pins 42, 44, respectively. Additionally, housing 30 includes a cavity 66 which receives at least a portion of cam follower 36 (see FIG. 3).

Referring to FIG. 4, the same illustrates bladeset assembly 22 in its locked position. In this position, pin receiving portions 62, 64 engage recesses 82, 84 of pins 42, 44, respectively. This engagement prevents movement of pins 42, 44 in direction 56 (see FIG. 3). Locking mechanism 24 includes a biasing element 70 that biases bracket 26 in a direction generally away from movable blade 32 to bring pin receiving portions 62, 64 into engagement with pins 42, 44. The biasing force generated by biasing element 70 is sufficient enough to hold blade assembly 22 in place as movable blade 32 reciprocates at a high speed relative to stationary blade 34 during operation of the hair cutting device 20.

Biasing element 70 is interposed between a base portion 74 of bracket 26 and a retaining tab 72 of housing 30 as shown. Although biasing element 70 is illustrated as a compression spring, it is contemplated that any form of biasing element may be employed. Further, although a single biasing element 70 is shown, it is contemplated that multiple biasing elements could be arranged to act upon bracket 26 as described herein. Yet further, while two pins 42, 44 are shown, it is contemplated that fewer or additional pins are optionally employed. One advantage of using two or more pins 42, 44 is that the same fully constrain bladeset assembly 22 relative to device 20 such that bladeset assembly 22 cannot rotate about the axis of one of pins 42, 44, and such that a cutting line 86 defined by a cutting region of bladeset assembly 22 is maintained in a direction perpendicular to a direction of extension of a longitudinal axis 50 (see FIG. 2) of device 20.

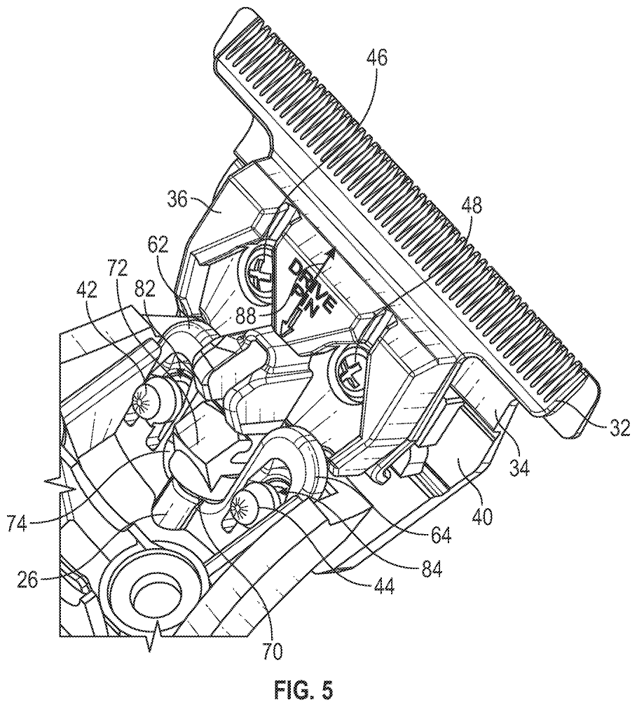

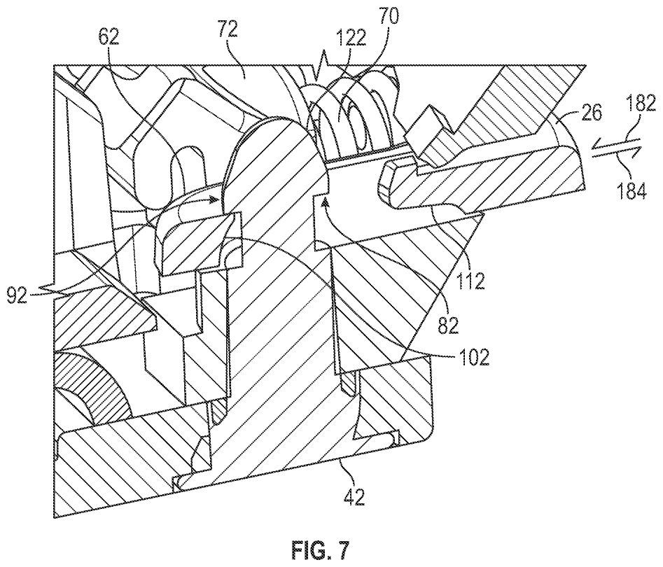

With reference to FIG. 5, bracket 26 has been moved in direction 88 against the biasing force provided by biasing element 70. Movement of bracket 26 in this direction disengages same from pins 42, 44. Bracket 26 may be moved as such by pressing upon the exposed portion thereof as shown in FIG. 1 in direction 132 as shown in FIG. 7. Blade assembly 22 may then be removed from device 20 by pulling it away in direction 56 (see FIG. 3). Accordingly, removal of blade assembly 22 is advantageously achieved by a push button connection, without the necessity of any hand tools.

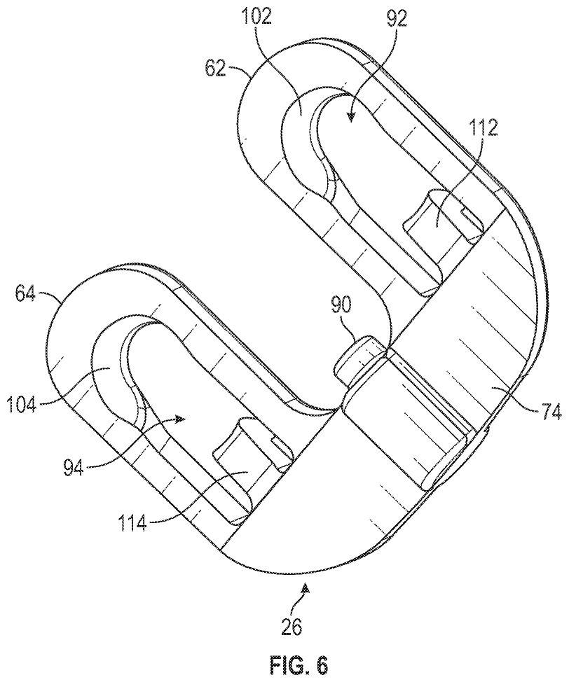

With reference to FIG. 6, the same shows bracket 26 in greater detail. As shown therein, each pin receiving portion 62, 64 defines pin receiving slots 92, 94. Pin receiving slots 92, 94 each include an arcuate interior surface 102, 104, respectively, configured for sliding engagement with pins 42, 44 as described below. A stopping tab 112 is situated within pin receiving slot 92. A stopping tab 114 is situated within pin receiving slot 104. As described below relative to FIG. 7, tabs 112, 114 act as retainers upon housing 30 to prevent biasing element 70 from biasing bracket 26 completely out of housing 30 when pins 42, 44 are not received in pin receiving slots 92, 94.

FIG. 7 illustrates pin 42 received in pin receiving slot 92 in cross section. While only pin 42 is shown in this view, the following description applies equally well to pin 44, its pin receiving portion 94, and so on. As can be seen in this view, recess 82 provides an undercut within which pin receiving portion 62 seats firmly as a result of being biased in direction 134 by spring 70 as shown. This undercut prevents axial movement of pin 42 relative to pin receiving slot 92, and hence prevents unintended removal of bladeset assembly 22 from device 20.

A head portion of pin 42 includes a domed surface 122 that slidably engages arcuate surface 102 when pins 42, 44 move within their corresponding bores 52, 54 in direction 58 (see FIG. 3). As a result, a ramping engagement is formed, which also causes bracket 26 to move in direction 132. In other words, the user need not depress bracket 26 in direction 132 to place blade assembly 22 in its locked position. Rather, user manipulation of bracket 26 is only required when transitioning blade assembly 22 from the locked position as shown in FIG. 7, to the unlocked position as shown in FIG. 2.

While a particular embodiment of the present electric hair cutting device with bladeset locking mechanism has been described herein, it will be appreciated by those skilled in the art that changes and modifications may be made thereto without departing from the invention in its broader aspects and as set forth in the following claims.

1. A hair cutting device, comprising:
a housing;
a bladeset assembly attached to the housing, the bladeset assembly including a stationary blade, a movable blade that is movable relative to the stationary blade, and at least one pin extending from the stationary blade;
a locking mechanism, the locking mechanism including a bracket and a biasing element, the biasing element acting upon the bracket to bias the bracket into engagement with the at least one pin; and
wherein the at least one pin includes a recess, and wherein the bracket seats in the recess in a locked position of the locking mechanism such that movement of the blade assembly in an unlocking direction parallel to a longitudinal axis of the at least one pin is prevented.

2. The hair cutting device of claim 1, wherein the at least one pin includes a pair of pins, which each one of the pair of pins including the recess.

3. The hair cutting device of claim 1, wherein the biasing element is a spring, and wherein the spring is interposed between a base portion of the bracket and a retaining tab of the housing.

4. The hair cutting device of claim 2, wherein the bracket includes a pair of pin receiving portions, wherein each one of the pair of pin receiving portions defines a slot, the slots arranged for receiving the pair of pins, respectively.

5. The hair cutting device of claim 4, wherein each pin receiving portion includes an arcuate surface facing an interior region of the slot.

6. The hair cutting device of claim 5, wherein each arcuate surface of each pin receiving portion is arranged for sliding engagement with a head portion of the pin received in the slot.

7. A hair cutting device, comprising:
a housing;
a bladeset assembly attached to the housing, the bladeset assembly including a stationary blade, a movable blade that is movable relative to the stationary blade, and a pair of pins extending from the stationary blade;
a locking mechanism, the locking mechanism including a bracket and a biasing element, the biasing element acting upon the bracket to bias the bracket into engagement with the pair of pins; and
wherein the bracket includes a pair of pin receiving portions, the pin receiving portions arranged to receive the pair of pins such that each one of the pair of pins extends through the pin receiving portion of the bracket, respectively.

8. The hair cutting device of claim 7, wherein each one of the pair of pins includes a recess, with each recess arranged such that each pin receiving portion of the pair of receiving portions seats within each recess, respectively.

9. The hair cutting device of claim 7, wherein the biasing element is interposed between a base portion of the bracket and a retaining tab of the housing.

10. The hair cutting device of claim 9, wherein the movable blade and stationary blade defining a cutting line, and wherein the biasing element biases the bracket away from the cutting line.

11. The hair cutting device of claim 7, wherein the pair of pins are fixedly attached to the stationary blade.

12. The hair cutting device of claim 7, wherein each one of the pair of pin receiving portions defines a slot, the slots arranged for receiving the pair of pins, respectively.

13. The hair cutting device of claim 12, wherein each pin receiving portion includes an arcuate surface facing an interior region of the slot.

14. The hair cutting device of claim 13, wherein each arcuate surface of each pin receiving portion is arranged for sliding engagement with a head portion of the pin received in the slot.

15. A hair cutting device, comprising:
a housing;
a bladeset assembly attached to the housing, the bladeset assembly including a stationary blade, a movable blade that is movable relative to the stationary blade, the movable blade and stationary blade defining a cutting line, and a pair of pins extending from the stationary blade;
a locking mechanism, the locking mechanism including a bracket and a biasing element, the bracket including a pair of pin receiving portions, the biasing element acting upon the bracket to bias the bracket into engagement with the at least one pin; and
wherein the biasing element is interposed between a base portion of the bracket and a retaining tab of the housing such that the bracket is biased away from the cutting line.

16. The hair cutting device of claim 15, wherein each one of the pair of pins includes a recess, with each recess arranged such that each pin receiving portion of the pair of pin receiving portions seats within each recess, respectively.

17. The hair cutting device of claim 16, wherein each one of the pair of pin receiving portions defines a slot (92, 94), the slots arranged for receiving the pair of pins, respectively.

18. The hair cutting device of claim 17, wherein each pin receiving portion includes an arcuate surface facing an interior region of the slot.

19. The hair cutting device of claim 18, wherein each arcuate surface of each pin receiving portion is arranged for sliding engagement with a head portion of the pin received in the slot.

20. The hair cutting device of claim 19, wherein the pair of pins are fixedly attached to the stationary blade.
